(19) United States
(12) Patent Application Publication
(10) Pub. No.: US 2013/0108345 A1
(43) Pub. Date: May 2, 2013

(54) IMAGE FORMATION APPARATUS, IMAGE FORMATION SYSTEM, AND PRINT CONTROL PROGRAM

(71) Applicant: OKI DATA CORPORATION, Tokyo (JP)

(72) Inventor: Mari YAMAMOTO, Tokyo (JP)

(73) Assignee: OKI DATA CORPORATION, Tokyo (JP)

(21) Appl. No.: 13/657,977

(22) Filed: Oct. 23, 2012

(30) Foreign Application Priority Data
Oct. 26, 2011 (JP) 2011-235199

(51) Int. Cl. B41J 11/42

(52) U.S. Cl. 400/76

(57) ABSTRACT

An image formation apparatus includes: a consumable housing unit configured to detachably house one of multiple types of consumables used for image formation; an image formation unit configured to execute printing of print data received from a host apparatus on a record medium in accordance with a print condition specified by the host apparatus; a printable mode determination unit configured to determine a currently executable print mode based on a type of a consumable installed in the consumable housing unit; and a print controller configured to determine whether or not the printing of the print data received from the host apparatus is possible based on the print conditions specified by the host apparatus and the executable print mode determined by the printable mode determination unit.

### CROSS REFERENCE TO RELATED APPLICATIONS

This application claims priority based on 35 USC 119 from prior Japanese Patent Application No. 2011-235199 filed on Oct. 26, 2011, entitled “IMAGE FORMATION APPARATUS, IMAGE FORMATION SYSTEM, AND PRINT CONTROL PROGRAM”, the entire contents of which are incorporated herein by reference.

### BACKGROUND OF THE INVENTION

### 1. Field of the Invention

This disclosure relates to an image formation apparatus, an image formation system, and a print control program in which printing is performed on a record medium by using multiple types of consumables.

Patent Document 1 discloses an exemplar technique related to a conventional image formation apparatus configured to perform printing on a record medium by using multiple types of consumables. In this technique, information on types of consumables is stored in memory tags attached to the respective consumables, and the type of a consumable installed in the image formation apparatus is identified by reading the type information from the memory tag attached to the consumable (Patent Document 1: Japanese Patent Application Publication No. 2010-175626, for example).

### SUMMARY OF THE INVENTION

The conventional image formation apparatus, however, outputs an image not intended by a user when a consumable necessary for print conditions specified by the user is not installed therein.

An object of an embodiment of the invention is to prevent output of an image not intended by a user.

A first aspect of the invention is an image formation apparatus, including: a consumable housing unit configured to detachably house one of multiple types of consumables used for image formation; an image formation unit configured to execute printing of print data received from a host apparatus on a record medium in accordance with a print condition specified by the host apparatus; a printable mode determination unit configured to determine a currently executable print mode from among all print modes based on a type of a consumable installed in the consumable housing unit; and a print controller configured to determine whether or not the printing of the print data received from the host apparatus is possible based on the print conditions specified by the host apparatus and the executable print mode determined by the printable mode determination unit.

A second aspect of the invention is an image formation system including: two or more image formation apparatuses according to the first aspect; and one or more host apparatuses each configured to transmit print data with a print condition specified to each of the image formation apparatuses.

A third aspect of the invention is a print control program executed by a controller of a host apparatus communicatively connected with image formation apparatuses each including a consumable housing unit configured to detachably house one of multiple types of consumables used for image formation. The print control program causes the controller to implement the following functions. One is a print condition set function configured to selectively accept any print mode designated by a user of the host apparatus from among all print modes executable by a selected one of the image formation apparatuses using any one or combination of all consumables installable in the consumable housing unit of the selected image formation apparatus, and set a print condition. Another is a print job creation function configured to transmit an inquiry about whether or not printing under the set print condition is possible to the selected image formation apparatus. When a reply indicating that the printing is possible is received from the selected image formation apparatus, the print job creation function causes the selected image formation apparatus to execute the printing by transmitting the print data. When a reply indicating that the printing is impossible is received from the selected image formation apparatus, the print job creation function transmits the inquiry about whether or not the printing under the set print condition is possible to all the other image formation apparatuses, displays information on one or more other image formation apparatuses each replying that the printing is possible on a display unit in a selectable manner as candidates for an alternative output destination, and causes the image formation apparatus selected from among the candidates to execute the printing by transmitting the print data thereto.

According to the aspect (s), it is possible to suppress output of an image which is not intended by a user.

### BRIEF DESCRIPTION OF THE DRAWINGS

FIG. 1 is a diagram showing a schematic configuration example of an image formation apparatus according to an embodiment of the invention.

FIG. 2 is an explanatory diagram of a configuration example of a printable mode determination unit and operations thereof.

FIG. 3 is a diagram showing a configuration example of an image formation system according to the embodiment of the invention.

FIG. 4 is a functional block diagram showing a functional configuration example of the image formation apparatus.

FIG. 5 is a functional block diagram showing a functional configuration example of a host apparatus.

FIG. 6 is a flowchart of processing in which the image formation apparatus determines printable modes.

FIG. 7 is a flowchart of processing in which the image formation apparatus receives an inquiry about whether or not printing is possible.

FIG. 8 is a flowchart of processing in which the image formation apparatus receives a print job.

FIG. 9 is a flowchart (first half) of print instruction processing in the host apparatus.

FIG. 10 is a flowchart (second half) of print instruction processing in the host apparatus.

FIG. 11 is a display example of a print mode set screen.

FIG. 12 is a display example of an alternative printer selection screen.

FIG. 13 is a display example of a non-printable display screen.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

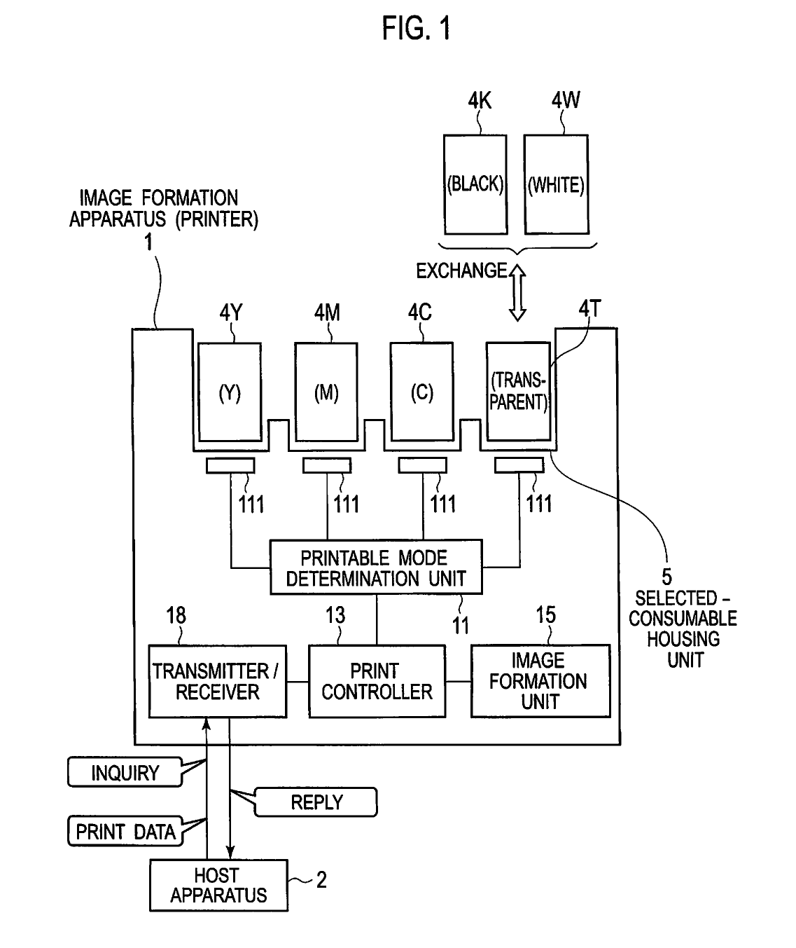

An embodiment of the invention is described below in detail with reference to the drawings as needed. FIG. 1 is a diagram showing a schematic configuration example of a color printer serving as an image formation apparatus according to the embodiment of the invention.

Examples of such an image formation apparatus include a copier, a facsimile, a digital multifunction device and the like, in addition to various printers. These apparatuses print a monochrome or color image on a record medium such as a paper sheet with use of consumables such as a toner and an ink, by the electronic photography method or the ink jet method.

Image formation apparatus (printer) 1 illustrated in FIG. 1 includes: three dedicated housing units in which three color consumable cartridges are used to form a general color image, i.e. yellow consumable cartridge 4Y, magenta consumable cartridge 4M, and cyan consumable cartridge 4C are respectively installed; and selected-consumable housing unit 5 (or a consumable housing unit) in which one of other consumable cartridges used to form an image other than a general color image is selected and installed.

For example, one cartridge is appropriately selected according to a print purpose from among black colorant consumable cartridge 4K for supplying a black developer for monochrome printing or color printing, white colorant consumable cartridge 4W for performing white printing on a transparent or colored record medium, and transparent colorant consumable cartridge 4T for applying a transparent coating agent onto a print surface to be protected and brightened. The selected cartridge is installed in selected-consumable housing unit 5.

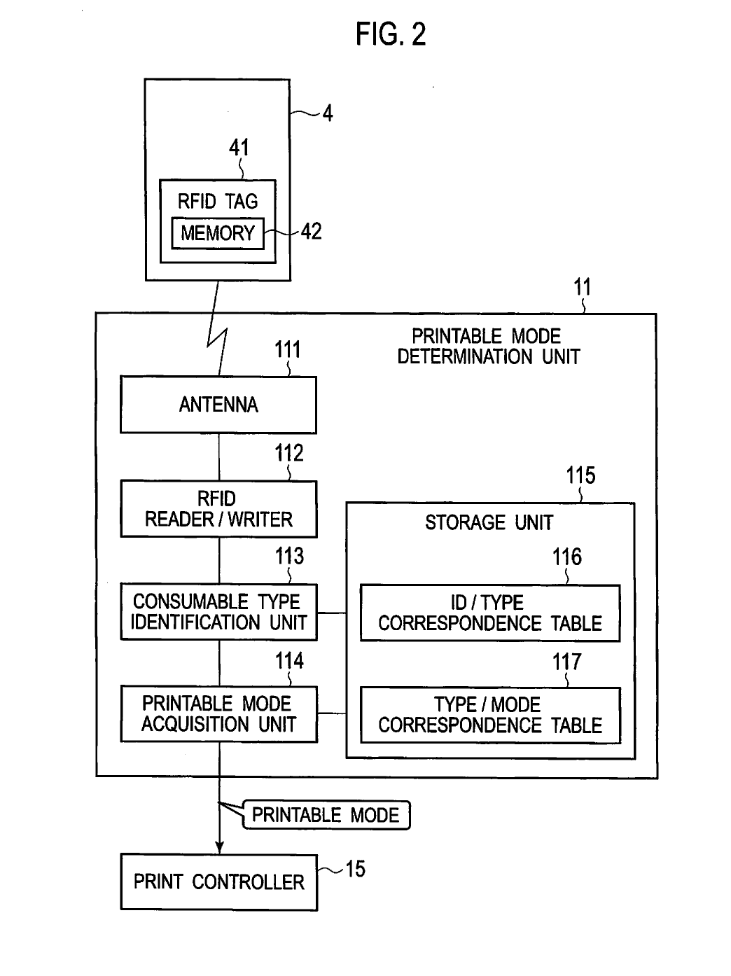

As shown in FIG. 2, RFID (Radio Frequency Identification) tag 41 including memory 42 formed of nonvolatile storage elements is attached to each consumable cartridge 4, and ID information on a type of a consumable and information on initial capacity of the consumable supplied in advance are stored in memory 42. In addition, when each consumable cartridge 4 is installed in image formation apparatus (printer) 1, printable mode determination unit 11, included in image formation apparatus (printer) 1, reads and writes data stored in relevant memory 42 via radio waves through antenna 111 disposed correspondingly to each housing unit. In the embodiment, a description is given of an example in which data of RFID tag 41 is read and written via radio waves. Note, however, that data of a nonvolatile memory included in consumable cartridge 4 may be read and written by using another non-contact or contact communication method. Alternatively, a method in which data is mechanically stored in consumable cartridge 4 to perform reading and writing may be used as well.

As shown in FIG. 2, printable mode determination unit 11 includes: RFID reader/writer 112 configured to read and write data of RFID tag 41 through antenna 111; consumable type identification unit 113 configured to identify a type of a consumable based on data read by RFID reader/writer 112; and printable mode acquisition unit 114 configured to acquire printable modes which are a set of executable print modes corresponding to the identified type of the consumable; and storage unit 115.

In addition, storage unit 115 is formed of a nonvolatile memory such as a flash memory and an EEPROM (Electrically Erasable Programmable Read-Only Memory), and includes: ID/type correspondence table 116 configured to specify a correspondence relationship between a type of a consumable and ID information stored in memory 42 in RFID tag 41; and type/mode correspondence table 117 configured to specify a correspondence relationship between a type of a consumable and printable modes.

Consumable type identification unit 113 is configured to check ID information read from RFID tag 41 against ID information registered in ID/type correspondence table 116, and thus identify a type of consumable cartridge 4, i.e. a type of a consumable. In addition, printable mode acquisition unit 114 is configured to acquire printable modes corresponding to the identified type of a consumable by checking the identified type of the consumable against the types of consumables registered in type/mode correspondence table 117. In this way, when consumable cartridge 4 installed in selected-consumable housing unit 5 is a transparent colorant consumable cartridge 4T, for example, the following three modes are determined as printable modes: a color print mode for performing color printing on a normal record medium; a color photograph print mode for performing color printing on a record medium for photographs and applying a transparent coating agent thereto; and a process black print mode for performing monochrome printing on a normal record medium by using process black (black obtained by mixing three colors).

Referring back to FIG. 1, printable modes determined by printable mode determination unit 11 are stored in an unillustrated storage unit. When host apparatus 2 causes image formation apparatus (printer) 1 to execute printing, host apparatus 2 first transmits an inquiry about whether or not printing is possible in a requested print mode, which is a print mode designated by a user. Print controller 13, receiving this inquiry through transmitter/receiver 18, determines whether or not the requested print mode is included in the printable modes stored in the storage unit, and causes transmitter/receiver 18 to transmit a reply to the inquiry. In this way, host apparatus 2 receiving the reply to the inquiry transmits a print job including print data to image formation apparatus (printer) 1 only when printing is executable in image formation apparatus (printer) 1, and causes image formation apparatus (printer) 1 to execute printing. When printing is not executable in image formation apparatus (printer) 1, host apparatus 2 can search for an alternative output destination to execute printing.

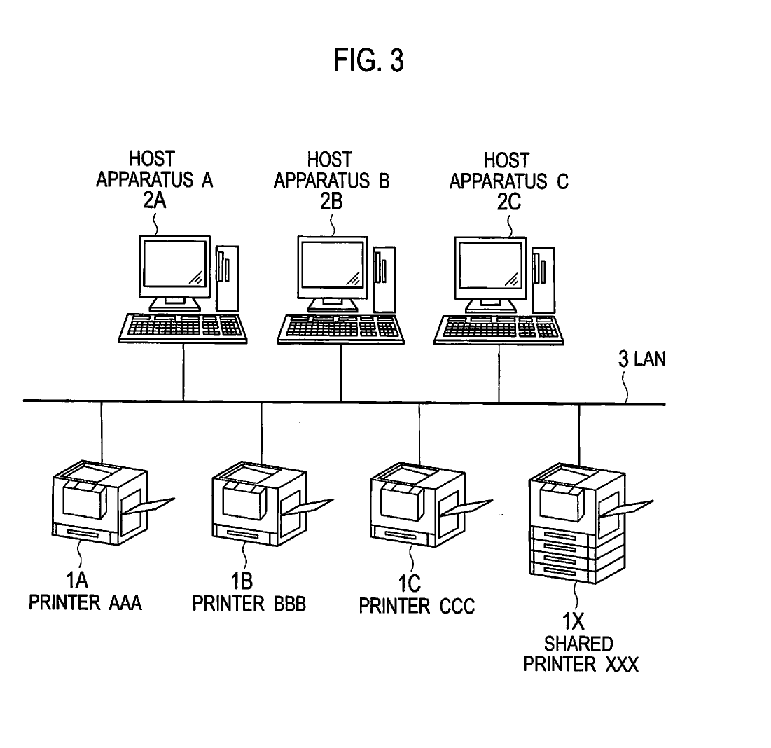

FIG. 3 is a diagram showing a configuration example of an image formation system in which printers 1A, 1B, 1C, 1X serving as image formation apparatuses 1 and host apparatuses 2A, 2B, 2C according to the embodiment are connected with each other through LAN (Local Area Network) 3. In this image formation system, it is assumed that print jobs created by host apparatuses 2A, 2B, 2C are transmitted to one of printers 1A, 1B, 1C, 1X through LAN 3, and the one of printers 1A, 1B, 1C, 1X spools the print jobs received from the host apparatus, executes the print jobs in a predetermined order to perform printing on record media, and sequentially stacks the printed record media on a delivery tray.

In the image formation system shown in FIG. 3, it is presumed that printer AAA (1A), printer BBB (1B) and printer CCC (1C) are installed in area a, area b and area c, respectively. Host apparatus A (2A), host apparatus B (2B) and host apparatus C (2C) use printer AAA (1A), printer BBB (1B) and printer CCC (1C) as ordinary output destinations, respectively. In addition, these types of printers are configured in such a way that when particular consumable cartridge 4 and a record media necessary for printing are not installed in an ordinary output destination, another printer having them installed therein can be selected as an alternative output destination.

It is preferable that the image formation system shown in FIG. 3 include shared printer XXX (1X) in which various consumable cartridges 4 and various record media can be simultaneously installed, and that all print modes selectable in printers 1A, 1B, 1C be executable by shared printer XXX (1X). Thereby, even when a desired print mode cannot be executed in a printer normally used by a user, one or more alternative output destinations can always be secured.

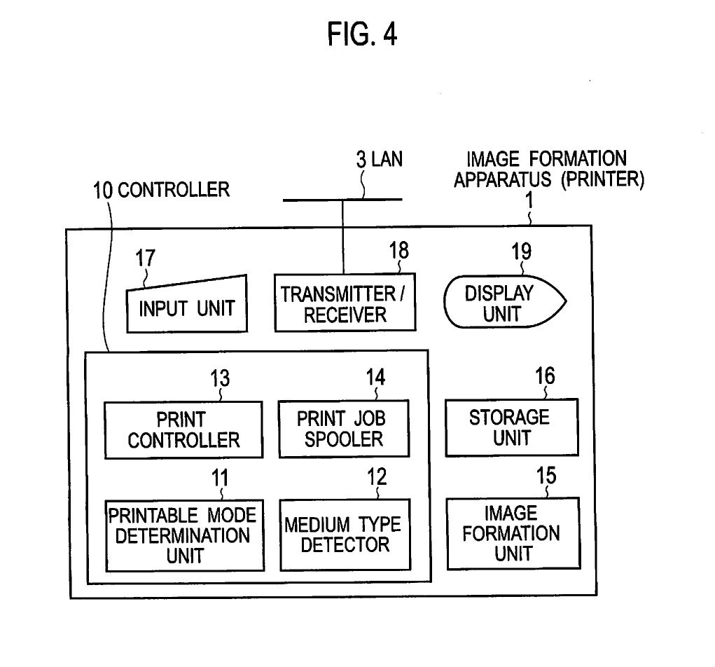

FIG. 4 is a functional block diagram showing a functional configuration example of image formation apparatus (printer) 1 according to the embodiment. As shown in FIG. 4, image formation apparatus 1 includes printable mode determination unit 11, medium type detector 12, print controller 13, print job spooler 14, image formation unit 15, storage unit 16, input unit 17, transmitter/receiver 18, and display unit 19.

Among them, printable mode determination unit 11, medium type detector 12, print controller 13 and print job spooler 14 are realized as follows. An unillustrated CPU (Central Processing Unit) included in controller 10 loads a program stored in a storage device, such as an unillustrated ROM (Read Only Memory), into an unillustrated main memory and executes the program.

Printable mode determination unit 11 is configured to determine printable modes being executable print modes in accordance with a type of a consumable cartridge 4 installed in selected-consumable housing unit 5-(FIG. 1) (see also FIG. 2). Medium type detector 12 is configured to detect a type of a record medium installed in an unillustrated medium housing unit. Detection of the type of the record medium may be performed by: using a sensor or the like; reading a type of a medium manually selected by a user though a selection section included in the medium housing unit; or setting a type of a medium by a user with use of display unit 19 and input unit 17.

Print conditions specified in an inquiry about whether or not printing is possible are received by transmitter/receiver 18 through LAN 3. Print controller 13 is configured to determine whether or not printing under these print conditions is possible, and instruct transmitter/receiver 18 to transmit a reply to the inquiry. At the same time, print controller 13 hands over a print job received by transmitter/receiver 18 through LAN 3 to print job spooler 14, and causes storage unit 16 to temporarily store the print job. In addition, when multiple print jobs are received by transmitter/receiver 18, print controller 13 determines an execution order of the print jobs in accordance with a predetermined preference, and causes image formation unit 15 to perform printing on a record medium by instructing image formation unit 15 to execute the print jobs.

Print job spooler 14 is configured to cause storage unit 16 to temporarily store information on a print job received by transmitter/receiver 18, and hand over information on a print job read from storage unit 16 in response to a request from image formation unit 15. Image formation unit 15 is configured to receive the information on the print job temporarily stored in storage unit 16 from print job spooler 14 in accordance with an instruction from print controller 13, feed a record medium installed in the medium housing unit, print print data included in the print job on the record medium, and deliver the record medium onto a delivery tray.

Information on a print job and various pieces of information required to execute printing are stored in storage unit 16 formed of RAM (Random Access Memory) or the like. In addition, input unit 17 formed of a touch panel, operation buttons and the like is configured to receive operation inputs made by a user. Display unit 19 formed of a liquid crystal display panel, display lamps and the like is configured to provide a user with various pieces of information on the state of an apparatus and a print job.

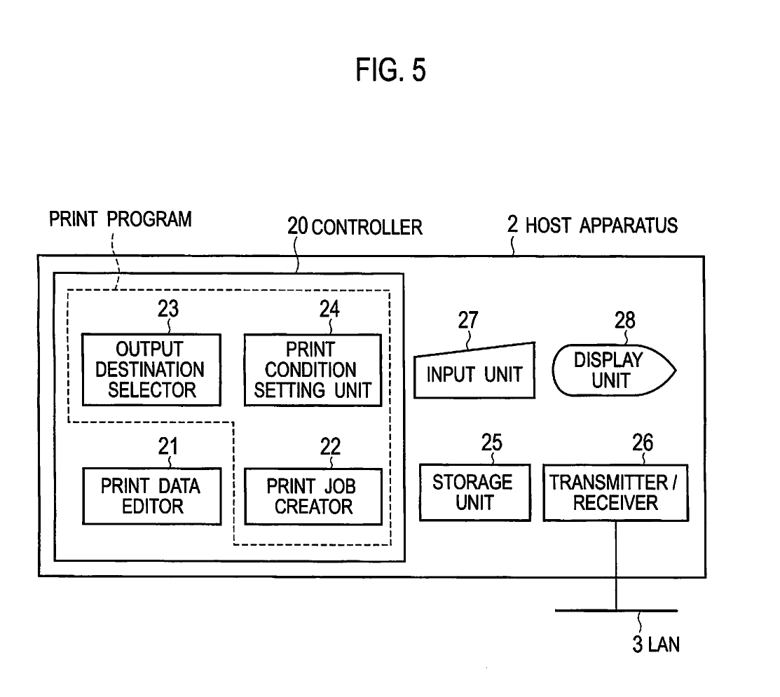

FIG. 5 is a functional block diagram showing a functional configuration example of host apparatus 2 according to the embodiment. As shown in FIG. 5, host apparatus 2 includes print data editor 21, print job creator 22, output destination selector 23, print condition setting unit 24, storage unit 25, transmitter/receiver 26, input unit 27, and display unit 28.

Among them, print data editor 21, print job creator 22, output destination selector 23, and print condition setting unit 24 are realized as follows. An unillustrated CPU included in controller 20 loads a program stored in a storage device, such as an unillustrated ROM, into an unillustrated main memory and executes the program. Among them, as shown in the drawing by a broken line, a print control program causes host apparatus 2 to function as print job creator 22, output destination selector 23 and print condition setting unit 24.

Storage unit 25 formed of RAM or the like is configured to store print data and various pieces of information required to edit and print the print data. Print data editor 21 is configured to execute a document generation program, for example, to provide a user with an editing function for generating print data being a print target. Output destination selector 23 is configured to provide a user with information on image formation apparatus 1 connected through LAN 3, and receives inputs for selecting an output destination by a user. Print condition setting unit 24 is configured to receive from a user print conditions for printing the generated print data.

Print job creator 22 is configured to create a print job including print data and parameters of various print conditions involving a requested print mode, and transmit the created print job to image formation apparatus 1 capable of printing under the printing conditions set by a user. At this time, when the output destination selected by the user is capable of executing the requested print mode, print job creator 22 causes transmitter/receiver 26 to transmit the print job to the output destination to perform printing. In contrast, when the output destination is not capable of executing the requested print mode, print job creator 22: searches for an alternative output destination capable of executing the requested print mode according to a selection made by the user, and causes the output destination to execute automatic printing; or presents candidates for an alternative output destination to the user, and causes the output destination selected by the user to execute printing.

Transmitter/receiver 26 is configured to transmit a print job or an inquiry about whether or not printing is possible to image formation apparatus 1 through LAN 3, and receive a reply to the inquiry or information on a result of printing from image formation apparatus 1.

In addition, input unit 27 is formed of a keyboard, a mouse and the like, and configured to receive operation inputs made by a user. Display unit 28 is formed of a liquid crystal display or the like, and configured to display a screen for editing print data or setting print conditions by a user, as well as a screen for providing information to a user.

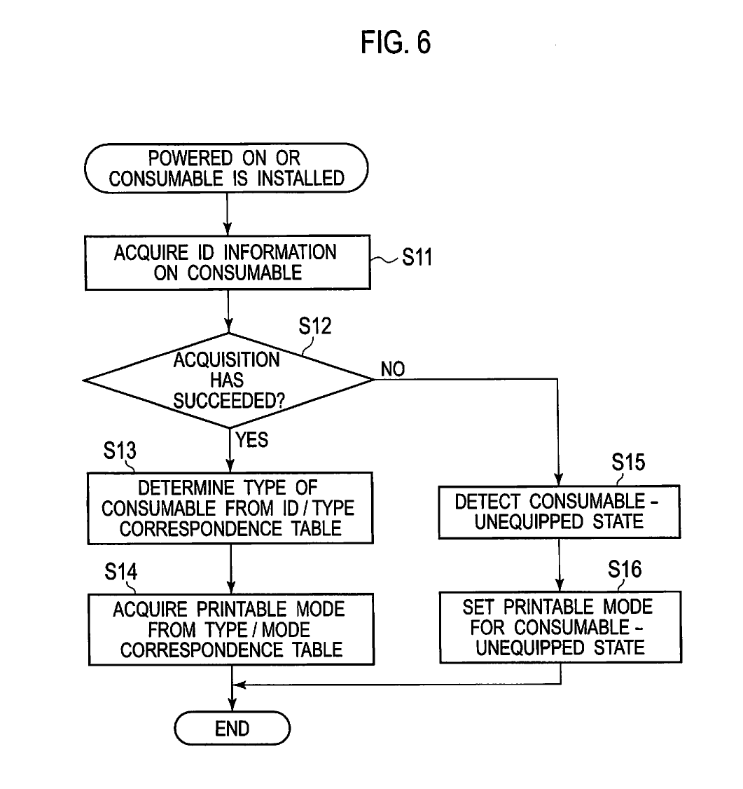

Subsequently, processing to be performed by image formation apparatus (printer) 1 for determining its printable modes is described by using the flowchart in FIG. 6. Processing in FIG. 6 is started when power of image formation apparatus 1 is turned on or new consumable cartridge 4 is installed in selected-consumable housing unit 5.

First, in step S11, RFID reader/writer 112 included in printable mode determination unit 11 acquires ID information from RFID tag 41 via radio waves through antenna 111. Here, RFID tag 91 is attached to consumable cartridge 4 installed in selected-consumable housing unit 5, and the ID information is stored in memory 42 to show types of consumables.

Next, in step S12, consumable type identification unit 113 determines whether or not acquisition of the ID information has succeeded. When acquisition of the ID information has succeeded (“Yes” in step S12), the process proceeds to step S13. When acquisition of the ID information has failed (“No” in step S12), the process proceeds to step S15.

In step S13, consumable type identification unit 113 checks the acquired ID information against ID information registered in ID/type correspondence table 116, and thus identifies a type of a consumable of consumable cartridge 4 installed in selected-consumable housing unit 5. Subsequently, in step S14, printable mode acquisition unit 114 checks the identified type of the consumable against types of consumables registered in type/mode correspondence table 117, thus acquires printable modes corresponding to the identified type of the consumable, and terminates processing by storing the acquired printable modes in storage unit 16.

On the other hand, in step S15, consumable type identification unit 113 determines that no consumable cartridge 4 is installed in selected-consumable housing unit 5, which is a consumable-unequipped state. Subsequently, in step S16, printable mode acquisition unit 114 sets a printable mode of the acquired result as a printable mode in the consumable-unequipped state, and terminates processing by storing the set printable mode in storage unit 16. Note that a printable mode in the consumable-unequipped state may also be registered in type/mode correspondence table 117 in advance, and the printable mode in the consumable-unequipped state may be acquired from type/mode correspondence table 117.

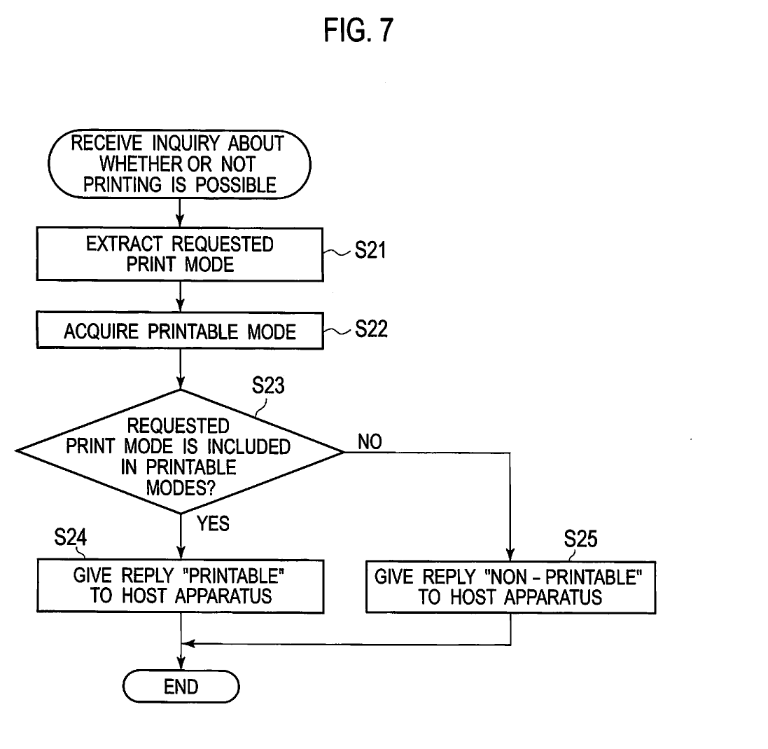

Next, processing to be performed when image formation apparatus (printer) 1 receives an inquiry about whether or not printing is possible is described by using the flowchart in FIG. 7. Processing in FIG. 7 is started when transmitter/receiver 18 of image formation apparatus 1 receives an inquiry about whether or not printing is possible from host apparatus 2 through LAN 3.

First, in step S21, print controller 13 extracts a requested print mode being an inquiry target from print conditions set in the received inquiry about whether or not printing is possible. Next, in step S22, print controller 13 acquires printable modes determined by printable mode determination unit 11 from storage unit 16.

Subsequently, in step S23, print controller 13 determines whether or not the extracted requested print mode is included in the acquired printable modes. When the extracted requested print mode is included in the acquired printable modes (“Yes” in step S23), the process proceeds to step S24. When the extracted requested print mode is not included in the acquired printable modes (“No” in step S23), the process proceeds to step S25.

In step S24, print controller 13 instructs transmitter/receiver 18 to give a reply “printable”, and transmitter/receiver 18 transmits a printable reply through LAN 3 to host apparatus 2 which has made the inquiry and then terminates the processing. On the other hand, in step S25, print controller 13 instructs transmitter/receiver 18 to give a reply “non-printable”, and transmitter/receiver 18 transmits a non-printable reply through LAN 3 to host apparatus 2 which has made the inquiry, and then terminates the processing.

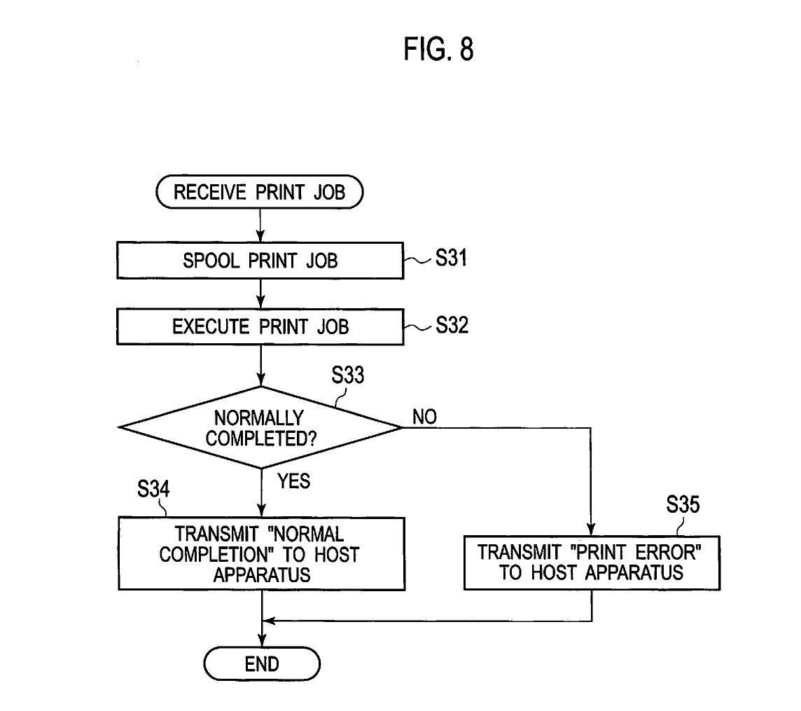

Next, processing to be performed when image formation apparatus (printer) 1 receives a print job is described by using the flowchart in FIG. 8. Processing in FIG. 8 is started when transmitter/receiver 18 of image formation apparatus 1 receives a print job from host apparatus 2 through LAN 3.

First, in step S31, print controller 13 hands over a received print job to print job spooler 14 and causes storage unit 16 to temporarily store the received print job. Subsequently, in step S32, print controller 13 determines a print job to be executed next in accordance with a predetermined preference from among print jobs temporarily stored in storage unit 16, hands over information on the determined print job to image formation unit 15, and instructs image formation unit 15 to execute printing. Thereby, image formation unit 15 acquires the instructed print job from print job spooler 14, prints print data on a record medium under print conditions specified in the print job, and delivers the record medium onto a delivery tray.

Subsequently, in step S33, print controller 13 determines whether or not the print job is normally completed. When the print job is normally completed (“Yes” in step S33), the process proceeds to step S39. When the print job is not normally completed (“No” in step S33), the process proceeds to step S35.

In step S34, print controller 13 instructs transmitter/receiver 18 to transmit “normal completion” to host apparatus 2 as the transmission source of the print job, and terminates processing after transmitter/receiver 18 transmits a normal completion notification to host apparatus 2 through LAN 3. On the other hand, in step S35, print controller 13 instructs transmitter/receiver 18 to transmit “print error” to host apparatus 2 as the transmission source of the print job, and terminates processing after transmitter/receiver 18 has transmitted a print error notification to host apparatus 2 through LAN 3.

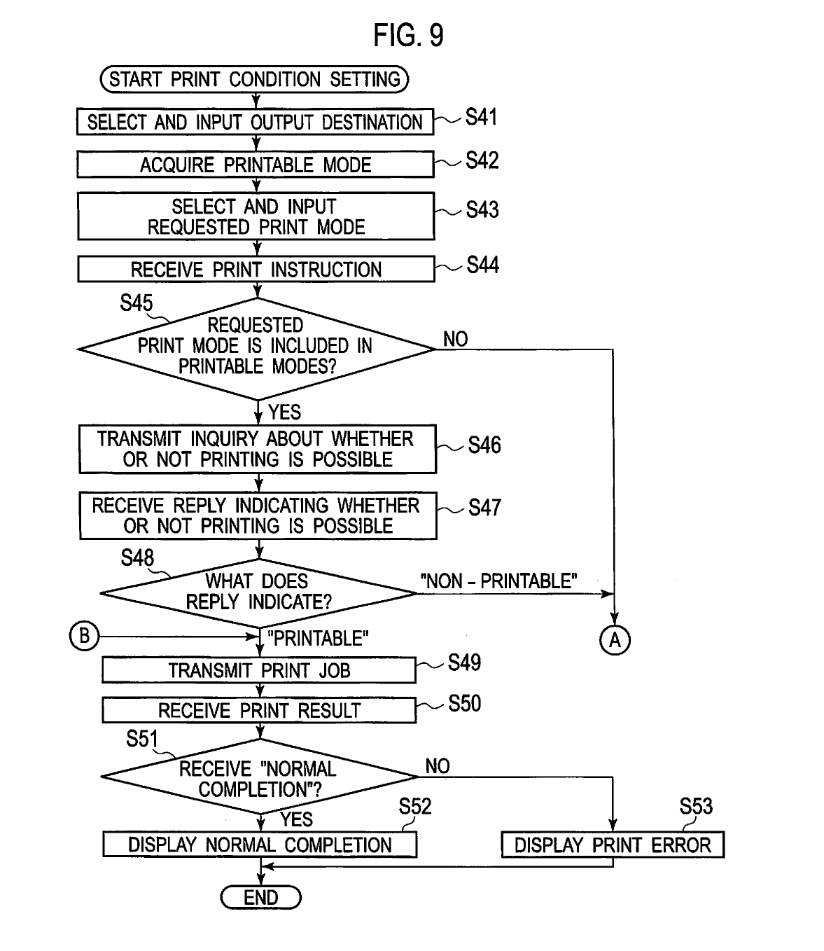

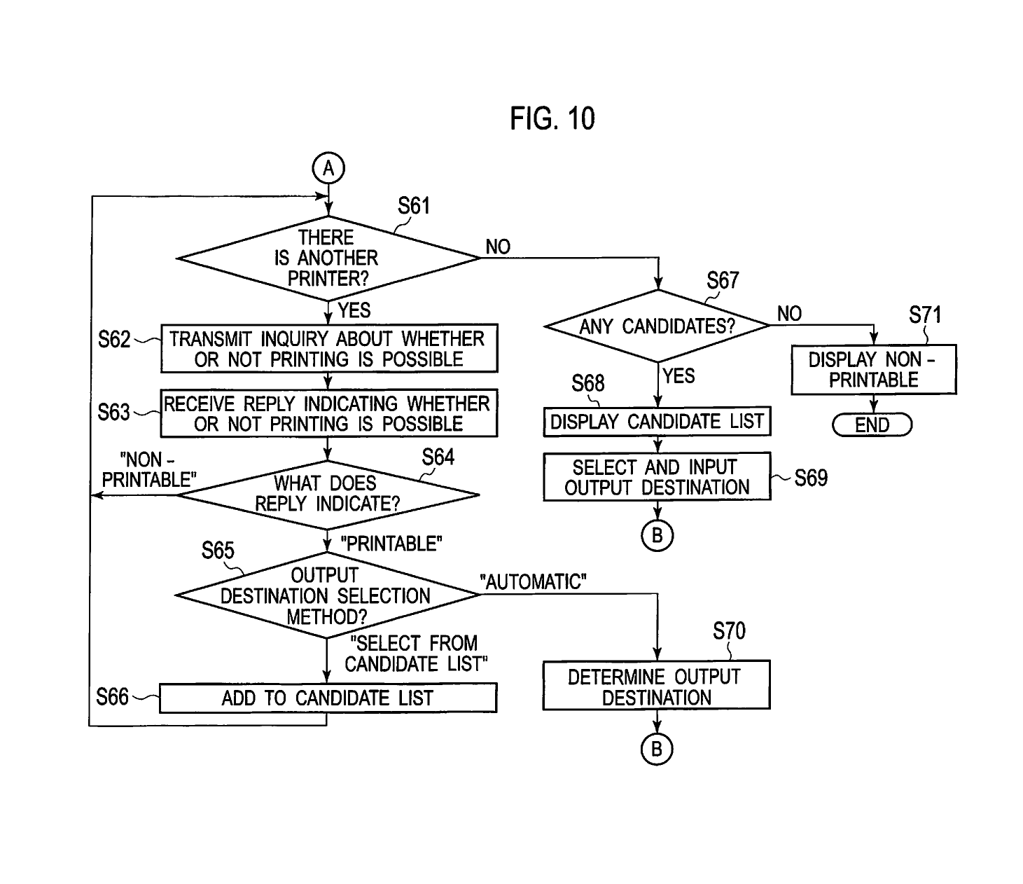

Subsequently, processing of print instructions to be performed by host apparatus 2 is described in detail by using flowcharts in FIG. 9 and FIG. 10. When print data is created by print data editor 21 and then a user performs predetermined print instruction operations in host apparatus 2, the processing shown in FIG. 9 is started.

First, in step S41, output destination selector 23 collects information on all usable printers currently connected through LAN 3, and lists the information on a screen. A user selects and inputs one of the listed printers as an output destination. As for this output destination, a default printer normally used by a user, or a printer used last by a user, is set as an initial value. A user may select and input another printer as needed. Output destination selector 23 receives input of the selected output destination.

Next, in step S42, print condition setting unit 24 acquires current printable modes from a selected output destination printer through transmitter/receiver 26 and LAN 3. Subsequently, in step S43, print condition setting unit 24 initially sets one of the acquired current printable modes as a requested print mode, and then receives input of a selected requested print mode from a user.

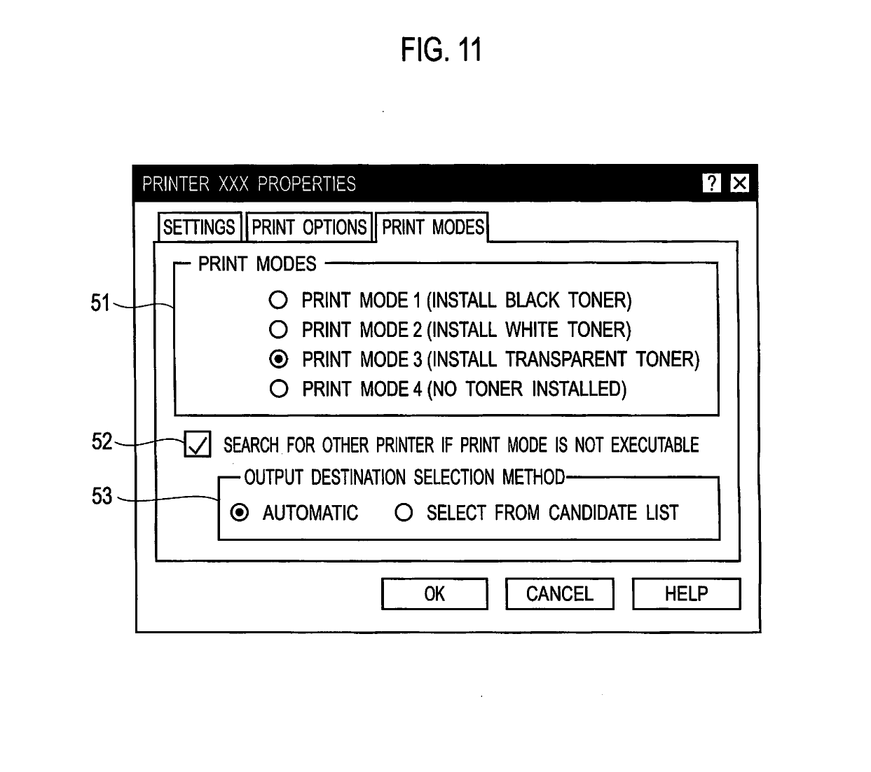

FIG. 11 is a display example of a print mode set screen used for selection and input of a requested print mode.

Printable modes acquired from a printer currently selected as an output destination are listed in print mode selection section 51. A user selects one (“print mode 3” in the embodiment) of the listed printable modes by a radio button, and then pushes (clicks with a mouse) the “OK” button in the lower part of the screen. Thereby, the print mode is selected and inputted as a requested print mode.

Check box 52 is an input section for designating whether or not to search for another printer capable of printing in a requested print mode. As in the example of FIG. 11, when a check mark is placed in check box 52, i.e. when another printer being an alternative output destination is to be searched for, the display is shown as follows. In print mode selection section 51, all print modes selectable in a currently selected output destination printer are shown with radio buttons regardless of the installation states of consumable cartridges 4. Moreover, radio buttons in output destination selection method specification section 53 are also shown. Here, when a radio button on the “automatic” side is selected in output destination selection method specification section 53, the system automatically selects an alternative output destination. When a radio button on the “select from a candidate list” side is selected in output destination selection method specification section 53, a user selects and inputs an alternative output destination from a candidate list shown on the screen by the system.

On the other hand, when no check mark is placed in check box 52, i.e. when another printer being an alternative output destination is not to be searched for, the display is shown as follows. In print mode selection section 51, only print modes corresponding to printable modes of a currently selected output destination printer are shown with radio buttons, and radio buttons of output destination selection method specification section 53 are not shown. An alternative printer capable of executing a desired print mode can be visually searched for by changing the output destination printer and then checking printable modes of each printer on a one-by-one basis. However, when a check mark is placed in check box 52 as described above, the system automatically searches for an alternative printer. Thus, it is possible to save much time and work for searching for an alternative printer.

Referring back to FIG. 9, after all the necessary settings of print conditions are completed, print condition setting unit 24 hands over control to print job creator 22 upon receipt of a print instruction from a user through a button operation and the like, in the subsequent step S49.

In the subsequent step S45, print job creator 22 determines whether or not the selected requested print mode is included in the printable modes acquired from an output destination printer. When the selected requested print mode is included in the printable modes (“Yes” in step S45), the process proceeds to step S46. When the selected requested print mode is not included in the printable modes (“No” in step S45), the process proceeds to step S61 in FIG. 10 through connector A.

In step S46, print job creator 22 sets current print conditions including the requested print mode, and transmits an inquiry about whether or not printing is possible to an output destination printer. In the subsequent step S47, print job creator 22 receives a reply indicating whether or not the printing is possible from the output destination printer. Next, in step S48, print job creator 22 makes a determination on a content of the reply indicating whether or not the printing is possible. When the reply indicates “printable” (“printable” in step S48), the process proceeds to step S49. When the reply indicates “non-printable” (“non-printable” in step S48), the process proceeds to step S61 in FIG. 10 through connector A.

In step S49, print job creator 22 performs processing such as conversion of necessary print data in accordance with print conditions set by a user, and thus creates a print job and transmits the created print job to an output destination printer. In the subsequent step S50, print job creator 22 receives a notification of a print result transmitted from the output destination printer. Next, in step S51, print job creator 22 determines whether or not “normal completion” is received as a print result. When “normal completion” is received (“Yes” in step S51), the process proceeds to step S52. When “normal completion” is not received (“No” in step S51), the process proceeds to step S53.

In step S52, print job creator 22 terminates processing after performing a normal completion display showing that printing has been normally completed. On the other hand, in step S53, print job creator 22 terminates processing after performing a print error display showing that an error has occurred during printing.

Additionally, in step S61 in FIG. 10, print job creator 22 determines whether or not there is another printer which is connected with LAN 3 and to which an inquiry about whether or not printing is possible is yet to be transmitted. When there is another printer (“Yes” in step S61), the process proceeds to step S62. When there is no other printer (“No” in step S61), the process proceeds to step S67.

In step S62, print job creator 22 transmits an inquiry about whether or not printing is possible to the printer as in the case of step S46 in FIG. 9. In the subsequent step S63, print job creator 22 receives a reply indicating whether or not printing is possible from the printer being the transmission destination. Next, in step S64, print job creator 22 makes a determination on a content of the received reply. When the reply indicates “printable” (“printable” in step S64), the process proceeds to step S65. When the reply indicates “non-printable” (“non-printable” in step S64), the process returns to step S61 and the above-described processing is repeated.

In step S65, print job creator 22 makes a determination on the output destination selection method set by a user (see FIG. 11). When the output destination selection method is “select from a candidate list” (“select from a candidate list” in step S65), the process proceeds to step S66. When the output destination selection method is “automatic” (“automatic” in step S65), the process proceeds to step S70.

In step S66, print job creator 22 adds the printer to a candidate list of alternative output destination printers. The process returns to step S61 and the above-described processing is repeated. Additionally, in step S70, print job creator 22 determines the printer as an output destination. Thereafter, the process proceeds to step S49 in FIG. 9 through connector B. As described above, the print job is transmitted to the printer and thus the printer executes printing.

On the other hand, in step S61, when there is no other printer or when an inquiry about whether or not printing is possible is completed for all the printers, print job creator 22 determines whether or not there is a candidate for an alternative printer in a candidate list in step S67. When there is a candidate (“Yes” in step S67), the process proceeds to step S68. When there is no candidate (“No” in step S67), the process proceeds to step S71.

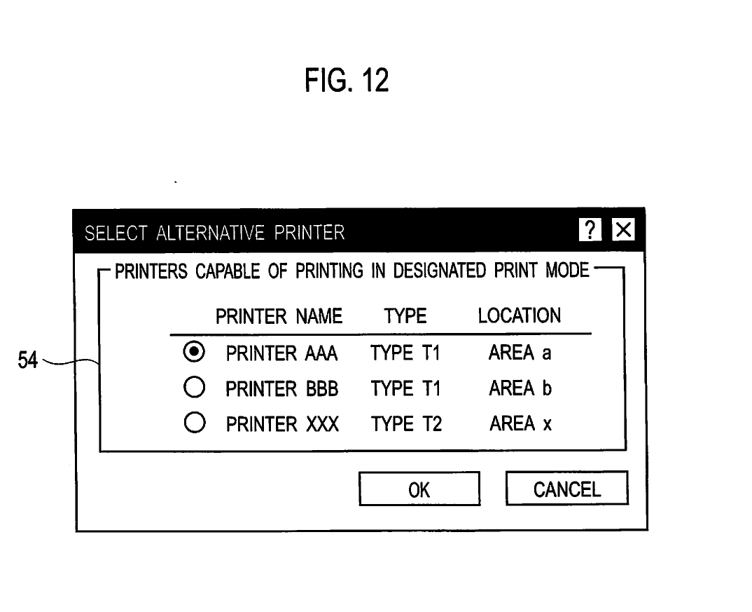

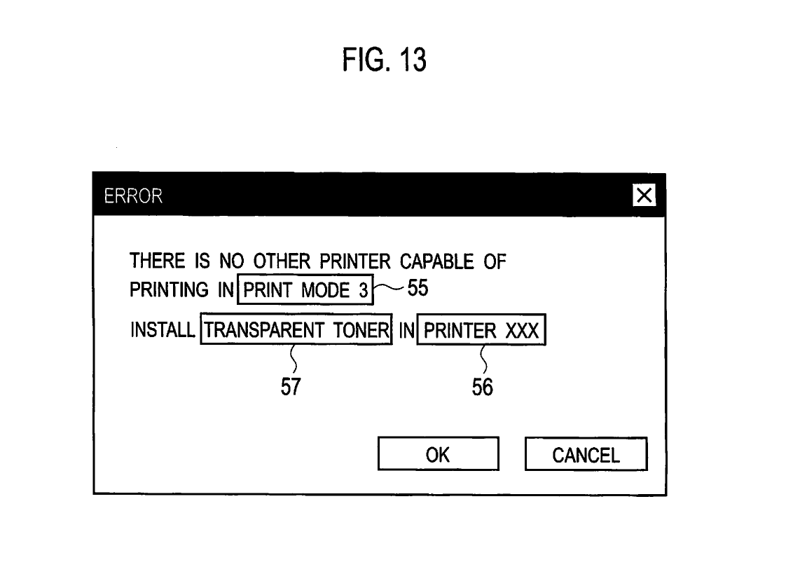

In step S68, print job creator 22 displays a candidate list of alternative printers on a screen, as illustrated in FIG. 12. In the subsequent step S69, print job creator 22 receives input of a selected output destination from a user, and the process proceeds to step S49 through connector B. As described above, the print job is transmitted to the printer and thus the printer executes printing. On the other hand, in step S71, since there is no alternative printer to be a candidate for an output destination, print job creator 22 terminates processing after performing an error display showing that printing cannot be executed, as illustrated in FIG. 13.

FIG. 12 is a display example of an alternative printer selection screen for a user to select an alternative output destination from alternative printer candidates presented by the system. Candidates for alternative printers capable of printing in a requested print mode set by a user are listed in output destination selection section 54. When a user selects one (“printer AAA” in the embodiment) of the candidates by a radio button and pushes (clicks with a mouse) the “OK” button in the lower part of the screen, the printer is set as an output destination.

FIG. 13 is a display example of a non-printable display screen displayed when there is no other printer to be a candidate for an output destination. Note that display contents of print mode name 55, output destination printer name 56 and consumable type name 57 are appropriately changed depending on setting contents of print conditions.

As described above, according to the embodiment, an inquiry about whether or not printing is possible in a print mode desired by a user is transmitted to an output destination in advance, and a print job is transmitted thereto only when the printing is possible. Thus, wasteful transmission of print data can be prevented.

In addition, according to the embodiment, even when a printer selected as an output destination by a user cannot execute a desired print mode, the system can search for another printer capable of executing the print mode to perform automatic printing, or present candidates for an alternative output destination to a user. Thus, a user can easily utilize an alternative output destination, and convenience of the image formation system is greatly improved.

Note that in the embodiment, only a print mode executable by an output destination printer is inquired in advance. However, whether or not a record medium required for execution of the print mode is housed in a medium housing unit may be simultaneously inquired, or insufficiency of remaining amounts of consumables may be checked by simultaneously transmitting the number of necessary print sheets.

The description of the embodiment of the invention is completed as above. However, the embodiment of the invention is not limited thereto, and various modifications can be made within the scope without departing from the gist of the invention.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image formation apparatus, comprising:
a consumable housing unit configured to detachably house one of multiple types of consumables used for image formation;
an image formation unit configured to execute printing of print data received from a host apparatus on a record medium in accordance with one or more print conditions specified by the host apparatus;
a printable mode determination unit configured to determine a currently executable print mode from among print modes based on a type of a consumable installed in the consumable housing unit; and
a print controller configured to determine whether or not the printing of the print data received from the host apparatus is possible based on the one or more print conditions specified by the host apparatus and the executable print mode determined by the printable mode determination unit.

2. The image formation apparatus according to claim 1, wherein
the print controller is configured to reply whether or not printing under the one or more print conditions specified by the host apparatus is possible, to the host apparatus being a transmission source.

3. The image formation apparatus according to claim 1, wherein
the print controller is configured to cause the image formation unit to execute the printing of the print data upon a determination that the printing of the print data received from the host apparatus is possible.

4. The image formation apparatus according to claim 1, wherein
the print controller is configured to reply that the printing of the print data is impossible to the host apparatus, being a transmission source, upon a determination that the printing of the print data received from the host apparatus is impossible.

5. The image formation apparatus according to claim 1, wherein
the consumable installed in the consumable housing unit includes at least one of a white colorant and a transparent colorant.

6. The image formation apparatus according to claim 1, wherein
the print modes include a print mode in which printing is performed by using any one of a white colorant and a transparent colorant.

7. The image formation apparatus according to claim 1, further comprising
a medium type detector configured to detect a type of a record medium housed in a medium housing unit, wherein
the print controller is configured to determine that the printing under the one or more print conditions is impossible when a record medium suitable for the specified print condition is not detected as being housed in the medium housing unit when the print controller receives from the host apparatus the print data or an inquiry as to whether or not the printing is possible.

8. An image formation system, comprising:
image formation apparatuses according to claim 1; and
at least one host apparatus each configured to transmit print data with a print condition specified to each of the image formation apparatuses.

9. The image formation system according to claim 8, wherein
each of the at least one host apparatus comprises a print condition setting unit configured to: selectively accept one of the image formation apparatuses as an output destination; selectively accept any print mode designated by a user of the at least one host apparatus from among all print modes executable by the accepted image formation apparatus using any one or combination of all consumables installable in the consumable housing unit of the accepted image formation apparatus; and set the print condition.

10. The image formation system according to claim 9, wherein each of the at least one host apparatus comprises a print job creator configured to:
transmit an inquiry as to whether or not the printing under the set print condition is possible to the accepted image formation apparatus as the output destination;
cause the accepted image formation apparatus to execute the printing by transmitting the print data thereto when a reply indicating that the printing is possible is received from the image formation apparatus;
transmit the inquiry as to whether or not the printing under the set print condition is possible to all the other image formation apparatuses when a reply indicating that the printing is impossible is received from the accepted image formation apparatus;
display information on a display unit in a selectable manner on one or more of the other image formation apparatuses having replied that the printing is possible, as candidates for an alternative output destination; and
cause one of the image formation apparatuses selected from the candidates to execute the printing by transmitting the print data thereto.
